(19) United States
(12) Patent Application Publication
(10) Pub. No.: US 2026/0346586 A1
(43) Pub. Date: Nov. 5, 2026

(54) MULTILAYER PROTECTIVE AND SOLAR CONTROL FILM

(71) Applicant: SAINT-GOBAIN PERFORMANCE PLASTICS CORPORATION, Malvern, PA (US)

(72) Inventors: Yongzhong WANG, Tucson, AZ (US); Sethumadhavan RAVICHANDRAN, San Diego, CA (US); Priyanka BISWAS, Santee, CA (US); Exel Yakira RAMOS DE GUTIERREZ, San Diego, CA (US)

(21) Appl. No.: 19/551,761

(22) Filed: Feb. 27, 2026

Related U.S. Application Data
(60) Provisional application No. 63/798,805, filed on May 2, 2025.

(51) Int. Cl. B32B 27/08; B32B 7/12

(52) U.S. Cl. CPC B32B 27/08; B32B 7/12; B32B 2255/10; B32B 2264/107; B32B 2264/301; B32B 2307/71; B32B 2307/7376; B32B 2571/00

(57) ABSTRACT

The present disclosure relates to a multilayer film that may include a protection component, and a solar control component. The solar control component may include a pressure sensitive adhesive. The multilayer film may include nano-ceramic particles. The multilayer film may have a delta haze value of not greater than about 4%, an ultraviolet (UV) degradation resistance of at least about 400 MJ/m² , and a total solar energy rejection (TSER) of at least about 30%.

### CROSS-REFERENCE TO RELATED APPLICATIONS

This Application claims priority under 35 U.S.C. § 119(e) to U.S. Provisional Patent Application No. 63/798,805 entitled “MULTILAYER PROTECTIVE AND SOLAR CONTROL FILM”, filed May 02, 2025, by Yongzhong WANG et al., which is assigned to the current assignee hereof and is incorporated herein by reference in its entirety.

### FIELD OF THE DISCLOSURE

The present disclosure relates to a multilayer protective film and methods of forming the same.

### BACKGROUND

Multilayer films are generally designed for application and protection of a particular surface. In particular, multilayer films may be applied to increase protection of glass surfaces, such as vehicle windshields. However, application of such protective films may inhibit solar control aspects of the glass. Accordingly, multilayer films that combine improved protection and improved solar control function are desired.

### SUMMARY

According to a first aspect, a multilayer film may include a protection component, and a solar control component. The protection component may include a protection component structural substrate, and a protective hard coating overlying the first structural substrate. The solar control component may include a pressure sensitive adhesive. The multilayer film may include nano-ceramic particles. The multilayer film may have a delta haze value of not greater than about 4%, an ultraviolet (UV) degradation resistance of at least about 400 MJ/m² , and a total solar energy rejection (TSER) of at least about 30%.

According to another aspect, a multilayer film may include a protection component, a solar control component, and a laminating adhesive layer between the protection component, and the solar control component. The protection component may include a protection component structural substrate, and a protective hard coating overlying the first structural substrate. The solar control component may include a solar control component structural substrate, a solar control coating overlying the solar control component structural substrate, and a pressure sensitive adhesive underlying the solar control structural substrate. The multilayer film may include nano-ceramic particles. The multilayer film comprises delta haze value of not greater than about 4%, a UV degradation resistance of at least about 400 MJ/m² , and a total solar energy rejection (TSER) of at least about 30%.

### BRIEF DESCRIPTION OF THE DRAWINGS

Embodiments are illustrated by way of example and are not limited to the accompanying figures.

FIG. 1 includes an illustration of a multilayer film according to embodiments described herein; and

FIG. 2 includes an illustration of a multilayer film according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multilayer film that may include a protection component, and a solar control component. The protection component may include a protection component structural substrate, and a protective hard coating overlying the protection structural substrate. The solar control component may include a pressure sensitive adhesive. The multilayer film may include nano-ceramic particles.

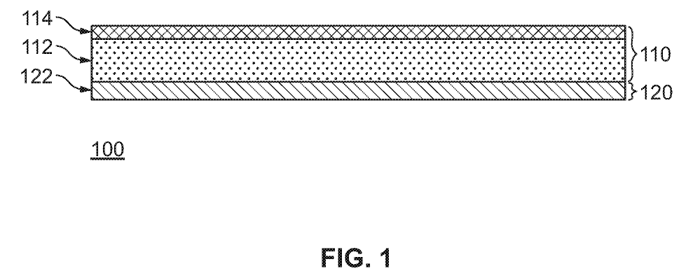

For purposes of illustration, FIG. 1 includes a diagram of a multilayer film 100 according to embodiments described herein. As shown in FIG. 1, a multilayer film 100 may include a protection component 110, and a solar control component 120. The protection component 110 may include a protection structural substrate 112, and a protective hard coating 114 overlying the protection structural substrate 130. The solar control component 120 may include a pressure sensitive adhesive 122.

According to particular embodiments, the multilayer film 100 may have a particular delta haze value. For purposes of embodiments described herein, the delta haze value of a particular component is defined as the haze after a Taber abrasion test minus the haze before a Taber abrasion test and is measured according to ASTM D-1044 (using wheel CS10F, 500 grams weight, and 100 cycles). According to particular embodiments, the multilayer film 100 may have a delta haze value of not greater than about 4%, such as not greater than about 3.5% or not greater than about 3.0% or not greater than about 2.5% or even not greater than about 2.0%. It will be appreciated that the delta haze value of the multilayer film 100 may be within a range between any of the values noted above. It will be further appreciated that the delta haze value of the multilayer film 100 may be any value between any of the values noted above.

According to particular embodiments, the multilayer film 100 may have a particular UV degradation resistance. For purposes of embodiments described herein, the UV degradation resistance of a particular component is defined as no visual cracking after exposure to certain UV irradiation and is measured according to ASTM G154 (test method cycle 4 with a fluorescent UV lamp with irradiance of 1.55 w/m² at 340 nm). According to particular embodiments, the multilayer film 100 may have a UV degradation resistance of at least about 400 MJ/m², such as at least about 450 MJ/m² or at least about 500 MJ/m² or at least about 550 MJ/m² or even at least about 600 MJ/m². It will be appreciated that the UV degradation resistance of the multilayer film 100 may be within a range between any of the values noted above. It will be further appreciated that the UV degradation resistance of the multilayer film 100 may be any value between any of the values noted above.

According to particular embodiments, the multilayer film 100 may have a particular total solar energy rejection (TSER). For purposes of embodiments described herein, the total solar energy rejection (TSER) of a particular component is defined as the proportion of solar energy that a component reflects or absorbs, rather than being transmitted through the component, and is measured according to ASTM D1003. According to particular embodiments, the multilayer film 100 may have a total solar energy rejection (TSER) of at least about 30%, such as at least about 32% or at least about 34% or at least about 36% or at least about 38% or at least about 40%. It will be appreciated that the total solar energy rejection (TSER) of the multilayer film 100 may be within a range between any of the values noted above. It will be further appreciated that the total solar energy rejection (TSER) of the multilayer film 100 may be any value between any of the values noted above.

According to particular embodiments, the multilayer film 100 may have a particular visual light transmittance (VLT). For purposes of embodiments described herein, the visual light transmittance (VLT) of a particular component is defined as the percentage of visible light passing through the component and is measured according to ASTM D1003.According to particular embodiments, the multilayer film 100 may have a visual light transmittance (VLT) of at least about 70%, such as at least about 72% or at least about 74% or at least about 76% or at least about 78% or at least about 80%. According to still other embodiments, the multilayer film 100 may have a visual light transmittance (VLT) of not greater than about 94%, such as not greater than about 92% or not greater than about 90% or not greater than about 88% or not greater than about 86% or even not greater than about 84%. It will be appreciated that the visual light transmittance (VLT) of the multilayer film 100 may be within a range between any of the minimum and maximum values noted above. It will be further appreciated that the visual light transmittance (VLT) of the multilayer film 100 may be any value between any of the minimum and maximum values noted above.

According to particular embodiments, the multilayer film 100 may have a particular haze. For purposes of embodiments described herein, the haze of a particular component is defined as the percentage of transmitted light that is scattered by the component at an angle greater than 2.5 degree from the incident beam and is measured according to ASTM D1003. According to particular embodiments, the multilayer film 100 may have a haze of at least about 0.5%, such as at least about 1.0% or at least about 1.5% or at least about 2.0% or even at least about 2.5%. According to still other embodiments, the multilayer film 100 may have a haze of not greater than about 4.0%, such as not greater than about 3.5% or even not greater than about 3.0%. It will be appreciated that the haze of the multilayer film 100 may be within a range between any of the minimum and maximum values noted above. It will be further appreciated that the haze of the multilayer film 100 may be any value between any of the minimum and maximum values noted above.

According to still other embodiments, the nano-ceramic particle may include antimony doped antimony tin oxide (ATO), cesium tungsten oxide (CWOx), and indium tin oxide (ITO), or any combination thereof. According to still other embodiment, the nano-ceramic particles may consist essentially of antimony doped antimony tin oxide (ATO), cesium tungsten oxide (CWOx), and indium tin oxide (ITO), or any combination thereof.

According to yet other embodiments, the protection component 110 may have a particular thickness. For example, the protection component 110 may have a thickness of at least about 10 microns, such as, at least about 15 microns or at least about 20 microns or at least about 30 microns or at least about 40 microns or at least about 50 microns or even at least about 100 microns. According to still other embodiments, the protection component 110 may have a thickness of not greater than about 250 microns, such as, not greater than about 225 microns or not greater than about 200 microns or not greater than about 175 microns or not greater than about 150 microns or even not greater than about 125 microns. It will be appreciated that the thickness of the protection component 110 may be within a range between any of the minimum and maximum values noted above. It will be further appreciated that the thickness of the protection component 110 may be any value between any of the minimum and maximum values noted above.

According to particular embodiments, the protection component 110 may have a particular visual light transmittance (VLT). For purposes of embodiments described herein, the visual light transmittance (VLT) of a particular component is defined as the percentage of visible light passing through the component and is measured according to ASTM D1003. According to particular embodiments, the protection component 110 may have a visual light transmittance (VLT) of at least about 70%, such as at least about 72% or at least about 74% or at least about 76% or at least about 78% or at least about 80%. According to still other embodiments, the protection component 110 may have a visual light transmittance (VLT) of not greater than about 94%, such as not greater than about 92% or not greater than about 90% or not greater than about 88% or not greater than about 86% or even not greater than about 84%. It will be appreciated that the visual light transmittance (VLT) of the protection component 110 may be within a range between any of the minimum and maximum values noted above. It will be further appreciated that the visual light transmittance (VLT) of the protection component 110 may be any value between any of the minimum and maximum values noted above.

According to particular embodiments, the protection component 110 may have a particular haze. For purposes of embodiments described herein, the haze of a particular component is defined as the percentage of transmitted light that is scattered by the component at an angle greater than 2.5 degree from the incident beam and is measured according to ASTM D1003. According to particular embodiments, the protection component 110 may have a haze of at least about 0.5%, such as at least about 1.0% or at least about 1.5% or at least about 2.0% or even at least about 2.5%. According to still other embodiments, the protection component 110 may have a haze of not greater than about 4.0%, such as not greater than about 3.5% or even not greater than about 3.0%. It will be appreciated that the haze of the protection component 110 may be within a range between any of the minimum and maximum values noted above. It will be further appreciated that the haze of the protection component 110 may be any value between any of the minimum and maximum values noted above.

According to still other embodiments, the protection component 110 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiment, the nano-ceramic particles may consist essentially of antimony doped antimony tin oxide (ATO), cesium tungsten oxide (CWOx), and indium tin oxide (ITO), or any combination thereof.

According to still other embodiments, the protection component structural substrate 112 may include particular materials. According to certain embodiments, protection component structural substrate 112 may include thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof. According to still other embodiments, the protection component structural substrate 112 may consist essentially of particular materials. According to certain embodiments, protection component structural substrate 112 may consist essentially of thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof.

According to yet other embodiments, the protection component structural substrate 112 may have a particular thickness. For example, the protection component structural substrate 112 may have a thickness of at least about 10 microns, such as, at least about 15 microns or at least about 20 microns or at least about 30 microns or at least about 40 microns or at least about 50 microns or even at least about 100 microns. According to still other embodiments, the protection component structural substrate 112 may have a thickness of not greater than about 250 microns, such as, not greater than about 225 microns or not greater than about 200 microns or not greater than about 175 microns or not greater than about 150 microns or even not greater than about 125 microns. It will be appreciated that the thickness of the protection component structural substrate 112 may be within a range between any of the minimum and maximum values noted above. It will be further appreciated that the thickness of the protection component structural substrate 112 may be any value between any of the minimum and maximum values noted above.

According to still other embodiments, the protective hard coating 114 may include particular materials. According to certain embodiments, protective hard coating 114 may include a UV curable hardcoat, a silicone hardcoat, a polyester hardcoat, a polyurethane hardcoat, a hardcoat comprising silica particles, a hardcoat comprising UV absorbers, or any combination thereof. According to still other embodiments, the protective hard coating 114 may consist essentially of particular materials. According to certain embodiments, protective hard coating 114 may consist essentially of a UV curable hardcoat, a silicone hardcoat, a polyester hardcoat, a polyurethane hardcoat, a hardcoat comprising silica particles, a hardcoat comprising UV absorbers, or any combination thereof.

According to yet other embodiments, the protective hard coating 114 may have a particular thickness. For example, the protective hard coating 114 may have a thickness of at least about 0.5 microns, such as, at least about 1.0 microns or at least about 2.0 microns or at least about 3.0 microns or at least about 4.0 microns or even at least about 5.0 microns. According to still other embodiments, the protective hard coating 114 may have a thickness of not greater than about 25 microns, such as, not greater than about 20 microns or even not greater than about 15 microns. It will be appreciated that the thickness of the protective hard coating 114 may be within a range between any of the minimum and maximum values noted above. It will be further appreciated that the thickness of the protective hard coating 114 may be any value between any of the minimum and maximum values noted above.

According to still other embodiments, the protective hard coating 114 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiments, the nano-ceramic particles may consist essentially of antimony doped antimony tin oxide (ATO), cesium tungsten oxide (CWOx), and indium tin oxide (ITO), or any combination thereof.

According to still other embodiments, the protective hard coating 114 may include acrylic binders, silicone binders, polyester binders, polyurethane binders, or any combination thereof.

According to yet other embodiments, the solar control component 120 may have a particular thickness. For example, the solar control component 120 may have a thickness of at least about 10 microns, such as, at least about 15 microns or at least about 20 microns or at least about 30 microns or at least about 40 microns or at least about 50 microns or even at least about 100 microns. According to still other embodiments, the solar control component 120 may have a thickness of not greater than about 250 microns, such as, not greater than about 225 microns or not greater than about 200 microns or not greater than about 175 microns or not greater than about 150 microns or even not greater than about 125 microns. It will be appreciated that the thickness of the solar control component 120 may be within a range between any of the minimum and maximum values noted above. It will be further appreciated that the thickness of the solar control component 120 may be any value between any of the minimum and maximum values noted above.

According to particular embodiments, the solar control component 120 may have a particular visual light transmittance (VLT). For purposes of embodiments described herein, the visual light transmittance (VLT) of a particular component is defined as the percentage of visible light passing through the component and is measured according to ASTM D1003.According to particular embodiments, the solar control component 120 may have a visual light transmittance (VLT) of at least about 70%, such as at least about 72% or at least about 74% or at least about 76% or at least about 78% or at least about 80%. According to still other embodiments, the solar control component 120 may have a visual light transmittance (VLT) of not greater than about 94%, such as not greater than about 92% or not greater than about 90% or not greater than about 88% or not greater than about 86% or even not greater than about 84%. It will be appreciated that the visual light transmittance (VLT) of the solar control component 120 may be within a range between any of the minimum and maximum values noted above. It will be further appreciated that the visual light transmittance (VLT) of the solar control component 120 may be any value between any of the minimum and maximum values noted above.

According to particular embodiments, the solar control component 120 may have a particular haze. For purposes of embodiments described herein, the haze of a particular component is defined as the percentage of transmitted light that is scattered by the component at an angle greater than 2.5 degree from the incident beam and is measured according to ASTM D1003. According to particular embodiments, the solar control component 120 may have a haze of at least about 0.5%, such as at least about 1.0% or at least about 1.5% or at least about 2.0% or even at least about 2.5%. According to still other embodiments, the solar control component 120 may have a haze of not greater than about 4.0%, such as not greater than about 3.5% or even not greater than about 3.0%. It will be appreciated that the haze of the solar control component 120 may be within a range between any of the minimum and maximum values noted above. It will be further appreciated that the haze of the solar control component 120 may be any value between any of the minimum and maximum values noted above.

According to still other embodiments, the solar control component 120 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiment, the nano-ceramic particles may consist essentially of antimony doped antimony tin oxide (ATO), cesium tungsten oxide (CWOx), and indium tin oxide (ITO), or any combination thereof.

According to still other embodiments, the pressure sensitive adhesive 122 may include particular materials. According to certain embodiments, pressure sensitive adhesive 122 may include an acrylic based pressure sensitive adhesive, a natural rubber-based pressure sensitive adhesive, a synthetic rubber-based pressure sensitive adhesive, a silicone-based pressure sensitive adhesive, or any combination thereof. According to still other embodiments, the pressure sensitive adhesive 122 may consist essentially of particular materials. According to certain embodiments, pressure sensitive adhesive 122 may consist essentially of an acrylic based pressure sensitive adhesive, a natural rubber-based pressure sensitive adhesive, a synthetic rubber-based pressure sensitive adhesive, a silicone-based pressure sensitive adhesive, or any combination thereof.

According to yet other embodiments, the pressure sensitive adhesive 122 may have a particular thickness. For example, the pressure sensitive adhesive 122 may have a thickness of at least about 0.5 microns, such as, at least about 1.0 microns or at least about 2.0 microns or at least about 3.0 microns or at least about 4.0 microns or even at least about 5.0 microns. According to still other embodiments, the pressure sensitive adhesive 122 may have a thickness of not greater than about 25 microns, such as, not greater than about 20 microns or even not greater than about 15 microns. It will be appreciated that the thickness of the pressure sensitive adhesive 122 may be within a range between any of the minimum and maximum values noted above. It will be further appreciated that the thickness of the pressure sensitive adhesive 122 may be any value between any of the minimum and maximum values noted above.

According to still other embodiments, the pressure sensitive adhesive 122 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiment, the nano-ceramic particles may consist essentially of antimony doped antimony tin oxide (ATO), cesium tungsten oxide (CWOx), and indium tin oxide (ITO), or any combination thereof.

According to still other embodiments, the pressure sensitive adhesive 122 may include acrylic binders, silicone binders, polyester binders, polyurethane binders, or any combination thereof.

Turning now to another embodiment, such embodiments described herein are generally directed to a multilayer film that may include a protection component, a solar control component, and a laminating adhesive layer between the protection component, and the solar control component. The protection component may include a protection component structural substrate, and a protective hard coating overlying the first structural substrate. The solar control component may include a solar control component structural substrate, a solar control coating overlying the solar control component structural substrate, and a pressure sensitive adhesive underlying the solar control structural substrate. The multilayer film may include nano-ceramic particles.

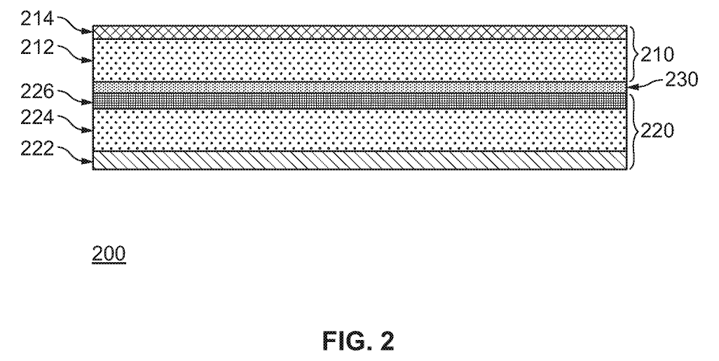

For purposes of illustration, FIG. 2 includes a diagram of a multilayer film 200 according to embodiments described herein. As shown in FIG. 2, a multilayer film 200 may include a protection component 210, a solar control component 220, and a laminating adhesive layer 230 between the protection component 210, and the solar control component 220. The protection component may include a protection component structural substrate 212, and a protective hard coating 212 overlying the protection component structural substrate 212. The solar control component 220 may include a solar control component structural substrate 224, a solar control coating 226 overlying the solar control component structural substrate 224, and a pressure sensitive adhesive 222 underlying the solar control structural substrate 224. The multilayer film 200 may include nano-ceramic particles.

According to particular embodiments, the multilayer film 200 may have a particular delta haze value. For purposes of embodiments described herein, the delta haze value of a particular component is defined as the haze after a Taber abrasion test minus the haze before a Taber abrasion test and is measured according to ASTM D-1044 (using wheel CS10F, 500 grams weight, and 100 cycles).According to particular embodiments, the multilayer film 200 may have a delta haze value of not greater than about 4%, such as not greater than about 3.5% or not greater than about 3.0% or not greater than about 2.5% or even not greater than about 2.0%. It will be appreciated that the delta haze value of the multilayer film 200 may be within a range between any of the values noted above. It will be further appreciated that the delta haze value of the multilayer film 200 may be any value between any of the values noted above.

According to particular embodiments, the multilayer film 200 may have a particular UV degradation resistance. For purposes of embodiments described herein, the UV degradation resistance of a particular component is defined as no visual cracking after exposure to certain UV irradiation and is measured according to ASTM G154 (test method cycle 4 with a fluorescent UV lamp with irradiance of 1.55 w/m² at 340 nm). According to particular embodiments, the multilayer film 100 may have a UV degradation resistance of at least about 400 MJ/m², such as at least about 450 MJ/m² or at least about 500 MJ/m² or at least about 550 MJ/m² or even at least about 600 MJ/m². It will be appreciated that the UV degradation resistance of the multilayer film 200 may be within a range between any of the values noted above. It will be further appreciated that the UV degradation resistance of the multilayer film 200 may be any value between any of the values noted above.

According to particular embodiments, the multilayer film 200 may have a particular total solar energy rejection (TSER). For purposes of embodiments described herein, the total solar energy rejection (TSER) of a particular component is defined as the proportion of solar energy that a component reflects or absorbs, rather than being transmitted through the component, and is measured according to ASTM D1003. According to particular embodiments, the multilayer film 200 may have a total solar energy rejection (TSER) of at least about 30%, such as at least about 32% or at least about 34% or at least about 36% or at least about 38% or at least about 40%. It will be appreciated that the total solar energy rejection (TSER) of the multilayer film 200 may be within a range between any of the values noted above. It will be further appreciated that the total solar energy rejection (TSER) of the multilayer film 200 may be any value between any of the values noted above.

According to particular embodiments, the multilayer film 200 may have a particular visual light transmittance (VLT). For purposes of embodiments described herein, the visual light transmittance (VLT) of a particular component is defined as the percentage of visible light passing through the component and is measured according to ASTM D1003. According to particular embodiments, the multilayer film 200 may have a visual light transmittance (VLT) of at least about 70%, such as at least about 72% or at least about 74% or at least about 76% or at least about 78% or at least about 80%. According to still other embodiments, the multilayer film 200 may have a visual light transmittance (VLT) of not greater than about 94%, such as not greater than about 92% or not greater than about 90% or not greater than about 88% or not greater than about 86% or even not greater than about 84%. It will be appreciated that the visual light transmittance (VLT) of the multilayer film 200 may be within a range between any of the minimum and maximum values noted above. It will be further appreciated that the visual light transmittance (VLT) of the multilayer film 200 may be any value between any of the minimum and maximum values noted above.

According to particular embodiments, the multilayer film 200 may have a particular haze. For purposes of embodiments described herein, the haze of a particular component is defined as the percentage of transmitted light that is scattered by the component at an angle greater than 2.5 degree from the incident beam and is measured according to ASTM D1003. According to particular embodiments, the multilayer film 200 may have a haze of at least about 0.5%, such as at least about 1.0% or at least about 1.5% or at least about 2.0% or even at least about 2.5%. According to still other embodiments, the multilayer film 200 may have a haze of not greater than about 4.0%, such as not greater than about 3.5% or even not greater than about 3.0%. It will be appreciated that the haze of the multilayer film 200 may be within a range between any of the minimum and maximum values noted above. It will be further appreciated that the haze of the multilayer film 200 may be any value between any of the minimum and maximum values noted above.

According to still other embodiments, the nano-ceramic particle may include antimony doped antimony tin oxide (ATO), cesium tungsten oxide (CWOx), and indium tin oxide (ITO), or any combination thereof. According to still other embodiment, the nano-ceramic particles may consist essentially of antimony doped antimony tin oxide (ATO), cesium tungsten oxide (CWOx), and indium tin oxide (ITO), or any combination thereof.

According to yet other embodiments, the protection component 210 may have a particular thickness. For example, the protection component 210 may have a thickness of at least about 10 microns, such as, at least about 15 microns or at least about 20 microns or at least about 30 microns or at least about 40 microns or at least about 50 microns or even at least about 200 microns. According to still other embodiments, the protection component 210 may have a thickness of not greater than about 250 microns, such as, not greater than about 225 microns or not greater than about 200 microns or not greater than about 175 microns or not greater than about 150 microns or even not greater than about 125 microns. It will be appreciated that the thickness of the protection component 210 may be within a range between any of the minimum and maximum values noted above. It will be further appreciated that the thickness of the protection component 210 may be any value between any of the minimum and maximum values noted above.

According to particular embodiments, the protection component 210 may have a particular visual light transmittance (VLT). For purposes of embodiments described herein, the visual light transmittance (VLT) of a particular component is defined as the percentage of visible light passing through the component and is measured according to ASTM D1003. According to particular embodiments, the protection component 210 may have a visual light transmittance (VLT) of at least about 70%, such as at least about 72% or at least about 74% or at least about 76% or at least about 78% or at least about 80%. According to still other embodiments, the protection component 210 may have a visual light transmittance (VLT) of not greater than about 94%, such as not greater than about 92% or not greater than about 90% or not greater than about 88% or not greater than about 86% or even not greater than about 84%. It will be appreciated that the visual light transmittance (VLT) of the protection component 210 may be within a range between any of the minimum and maximum values noted above. It will be further appreciated that the visual light transmittance (VLT) of the protection component 210 may be any value between any of the minimum and maximum values noted above.

According to particular embodiments, the protection component 210 may have a particular haze. For purposes of embodiments described herein, the haze of a particular component is defined as defined as the percentage of transmitted light that is scattered by the component at an angle greater than 2.5 degree from the incident beam and is measured according to ASTM D1003. According to particular embodiments, the protection component 210 may have a haze of at least about 0.5%, such as at least about 1.0% or at least about 1.5% or at least about 2.0% or even at least about 2.5%. According to still other embodiments, the protection component 210 may have a haze of not greater than about 4.0%, such as not greater than about 3.5% or even not greater than about 3.0%. It will be appreciated that the haze of the protection component 210 may be within a range between any of the minimum and maximum values noted above. It will be further appreciated that the haze of the protection component 210 may be any value between any of the minimum and maximum values noted above.

According to still other embodiments, the protection component 210 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiment, the nano-ceramic particles may consist essentially of antimony doped antimony tin oxide (ATO), cesium tungsten oxide (CWOx), and indium tin oxide (ITO), or any combination thereof.

According to still other embodiments, the protection component structural substrate 212 may include particular materials. According to certain embodiments, protection component structural substrate 212 may include thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof. According to still other embodiments, the protection component structural substrate 212 may consist essentially of particular materials. According to certain embodiments, protection component structural substrate 212 may consist essentially of thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof.

According to yet other embodiments, the protection component structural substrate 212 may have a particular thickness. For example, the protection component structural substrate 212 may have a thickness of at least about 10 microns, such as, at least about 15 microns or at least about 20 microns or at least about 30 microns or at least about 40 microns or at least about 50 microns or even at least about 200 microns. According to still other embodiments, the protection component structural substrate 212 may have a thickness of not greater than about 250 microns, such as, not greater than about 225 microns or not greater than about 200 microns or not greater than about 175 microns or not greater than about 150 microns or even not greater than about 125 microns. It will be appreciated that the thickness of the protection component structural substrate 212 may be within a range between any of the minimum and maximum values noted above. It will be further appreciated that the thickness of the protection component structural substrate 212 may be any value between any of the minimum and maximum values noted above.

According to still other embodiments, the protective hard coating 214 may include particular materials. According to certain embodiments, protective hard coating 214 may include a UV curable hardcoat, a silicone hardcoat, a polyester hardcoat, a polyurethane hardcoat, a hardcoat comprising silica particles, a hardcoat comprising UV absorbers, or any combination thereof. According to still other embodiments, the protective hard coating 214 may consist essentially of particular materials. According to certain embodiments, protective hard coating 214 may consist essentially of a UV curable hardcoat, a silicone hardcoat, a polyester hardcoat, a polyurethane hardcoat, a hardcoat comprising silica particles, a hardcoat comprising UV absorbers, or any combination thereof.

According to yet other embodiments, the protective hard coating 214 may have a particular thickness. For example, the protective hard coating 214 may have a thickness of at least about 0.5 microns, such as, at least about 1.0 microns or at least about 2.0 microns or at least about 3.0 microns or at least about 4.0 microns or even at least about 5.0 microns. According to still other embodiments, the protective hard coating 214 may have a thickness of not greater than about 25 microns, such as, not greater than about 20 microns or even not greater than about 15 microns. It will be appreciated that the thickness of the protective hard coating 214 may be within a range between any of the minimum and maximum values noted above. It will be further appreciated that the thickness of the protective hard coating 214 may be any value between any of the minimum and maximum values noted above.

According to still other embodiments, the protective hard coating 214 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiment, the nano-ceramic particles may consist essentially of antimony doped antimony tin oxide (ATO), cesium tungsten oxide (CWOx), and indium tin oxide (ITO), or any combination thereof.

According to still other embodiments, the protective hard coating 214 may include acrylic binders, silicone binders, polyester binders, polyurethane binders, or any combination thereof.

According to yet other embodiments, the solar control component 220 may have a particular thickness. For example, the solar control component 220 may have a thickness of at least about 10 microns, such as, at least about 15 microns or at least about 20 microns or at least about 30 microns or at least about 40 microns or at least about 50 microns or even at least about 200 microns. According to still other embodiments, the solar control component 220 may have a thickness of not greater than about 250 microns, such as, not greater than about 225 microns or not greater than about 200 microns or not greater than about 175 microns or not greater than about 150 microns or even not greater than about 125 microns. It will be appreciated that the thickness of the solar control component 220 may be within a range between any of the minimum and maximum values noted above. It will be further appreciated that the thickness of the solar control component 220 may be any value between any of the minimum and maximum values noted above.

According to particular embodiments, the solar control component 220 may have a particular visual light transmittance (VLT). For purposes of embodiments described herein, the visual light transmittance (VLT) of a particular component is defined as the percentage of visible light passing through the component and is measured according to ASTM D1003.According to particular embodiments, the solar control component 220 may have a visual light transmittance (VLT) of at least about 70%, such as at least about 72% or at least about 74% or at least about 76% or at least about 78% or at least about 80%. According to still other embodiments, the solar control component 220 may have a visual light transmittance (VLT) of not greater than about 94%, such as not greater than about 92% or not greater than about 90% or not greater than about 88% or not greater than about 86% or even not greater than about 84%. It will be appreciated that the visual light transmittance (VLT) of the solar control component 220 may be within a range between any of the minimum and maximum values noted above. It will be further appreciated that the visual light transmittance (VLT) of the solar control component 220 may be any value between any of the minimum and maximum values noted above.

According to particular embodiments, the solar control component 220 may have a particular haze. For purposes of embodiments described herein, the haze of a particular component is defined as the percentage of transmitted light that is scattered by the component at an angle greater than 2.5 degree from the incident beam and is measured according to ASTM D1003. According to particular embodiments, the solar control component 220 may have a haze of at least about 0.5%, such as at least about 1.0% or at least about 1.5% or at least about 2.0% or even at least about 2.5%. According to still other embodiments, the solar control component 220 may have a haze of not greater than about 4.0%, such as not greater than about 3.5% or even not greater than about 3.0%. It will be appreciated that the haze of the solar control component 220 may be within a range between any of the minimum and maximum values noted above. It will be further appreciated that the haze of the solar control component 220 may be any value between any of the minimum and maximum values noted above.

According to still other embodiments, the solar control component 220 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiment, the nano-ceramic particles may consist essentially of antimony doped antimony tin oxide (ATO), cesium tungsten oxide (CWOx), and indium tin oxide (ITO), or any combination thereof.

According to still other embodiments, the solar control component structural substrate 224 may include particular materials. According to certain embodiments, solar control component structural substrate 224 may include thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof. According to still other embodiments, the solar control component structural substrate 224 may consist essentially of particular materials. According to certain embodiments, solar control component structural substrate 224 may consist essentially of thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof.

According to yet other embodiments, the solar control component structural substrate 224 may have a particular thickness. For example, the solar control component structural substrate 224 may have a thickness of at least about 10 microns, such as, at least about 15 microns or at least about 20 microns or at least about 30 microns or at least about 40 microns or at least about 50 microns or even at least about 200 microns. According to still other embodiments, the solar control component structural substrate 224 may have a thickness of not greater than about 250 microns, such as, not greater than about 225 microns or not greater than about 200 microns or not greater than about 175 microns or not greater than about 150 microns or even not greater than about 125 microns. It will be appreciated that the thickness of the solar control component structural substrate 224 may be within a range between any of the minimum and maximum values noted above. It will be further appreciated that the thickness of the solar control component structural substrate 224 may be any value between any of the minimum and maximum values noted above.

According to still other embodiments, the solar control coating 226 may include particular materials. According to certain embodiments, solar control coating 226 may include as UV curable, polyester binders, or urethane binder. According to still other embodiments, the solar control coating 226 may consist essentially of particular materials. According to certain embodiments, solar control coating 226 may consist essentially of as UV curable, polyester binders, or urethane binder.

According to yet other embodiments, the solar control coating 226 may have a particular thickness. For example, the solar control coating 226 may have a thickness of at least about 0.5 microns, such as, at least about 1.0 microns or at least about 2.0 microns or at least about 3.0 microns or at least about 4.0 microns or even at least about 5.0 microns. According to still other embodiments, the solar control coating 226 may have a thickness of not greater than about 25 microns, such as, not greater than about 20 microns or even not greater than about 15 microns. It will be appreciated that the thickness of the solar control coating 226 may be within a range between any of the minimum and maximum values noted above. It will be further appreciated that the thickness of the solar control coating 226 may be any value between any of the minimum and maximum values noted above.

According to still other embodiments, the solar control coating 226 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiments, the nano-ceramic particles may consist essentially of antimony doped antimony tin oxide (ATO), cesium tungsten oxide (CWOx), and indium tin oxide (ITO), or any combination thereof.

According to still other embodiments, the pressure sensitive adhesive 222 may include particular materials. According to certain embodiments, pressure sensitive adhesive 222 may include an acrylic based pressure sensitive adhesive, a natural rubber-based pressure sensitive adhesive, a synthetic rubber-based pressure sensitive adhesive, a silicone-based pressure sensitive adhesive, or any combination thereof. According to still other embodiments, the pressure sensitive adhesive 222 may consist essentially of particular materials. According to certain embodiments, pressure sensitive adhesive 222 may consist essentially of an acrylic based pressure sensitive adhesive, a natural rubber-based pressure sensitive adhesive, a synthetic rubber-based pressure sensitive adhesive, a silicone-based pressure sensitive adhesive, or any combination thereof.

According to yet other embodiments, the pressure sensitive adhesive 222 may have a particular thickness. For example, the pressure sensitive adhesive 222 may have a thickness of at least about 0.5 microns, such as, at least about 1.0 microns or at least about 2.0 microns or at least about 3.0 microns or at least about 4.0 microns or even at least about 5.0 microns. According to still other embodiments, the pressure sensitive adhesive 222 may have a thickness of not greater than about 25 microns, such as, not greater than about 20 microns or even not greater than about 15 microns. It will be appreciated that the thickness of the pressure sensitive adhesive 222 may be within a range between any of the minimum and maximum values noted above. It will be further appreciated that the thickness of the pressure sensitive adhesive 222 may be any value between any of the minimum and maximum values noted above.

According to still other embodiments, the pressure sensitive adhesive 222 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiment, the nano-ceramic particles may consist essentially of antimony doped antimony tin oxide (ATO), cesium tungsten oxide (CWOx), and indium tin oxide (ITO), or any combination thereof.

According to still other embodiments, the pressure sensitive adhesive 222 may include acrylic binders, silicone binders, polyester binders, polyurethane binders, or any combination thereof.

According to yet other embodiments, the laminate adhesive layer 230 may have a particular thickness. For example, the laminate adhesive layer 230 may have a thickness of at least about 0.5 microns, such as, at least about 1.0 microns or at least about 2.0 microns or at least about 3.0 microns or at least about 4.0 microns or even at least about 5.0 microns. According to still other embodiments, the laminate adhesive layer 230 may have a thickness of not greater than about 25 microns, such as, not greater than about 20 microns or even not greater than about 15 microns. have a thickness of at least about 10 microns, such as, at least about 15 microns or at least about 20 microns or at least about 30 microns or at least about 40 microns or at least about 50 microns or even at least about 200 microns. It will be appreciated that the thickness of the laminate adhesive layer 230 may be within a range between any of the minimum and maximum values noted above. It will be further appreciated that the thickness of the laminate adhesive layer 230 may be any value between any of the minimum and maximum values noted above.

According to particular embodiments, the laminate adhesive layer 230 may have a particular visual light transmittance (VLT). For purposes of embodiments described herein, the visual light transmittance (VLT) of a particular component is defined as the percentage of visible light passing through the component and is measured according to ASTM D1003. According to particular embodiments, the laminate adhesive layer 230 may have a visual light transmittance (VLT) of at least about 70%, such as at least about 72% or at least about 74% or at least about 76% or at least about 78% or at least about 80%. According to still other embodiments, the laminate adhesive layer 230 may have a visual light transmittance (VLT) of not greater than about 94%, such as not greater than about 92% or not greater than about 90% or not greater than about 88% or not greater than about 86% or even not greater than about 84%. It will be appreciated that the visual light transmittance (VLT) of the laminate adhesive layer 230 may be within a range between any of the minimum and maximum values noted above. It will be further appreciated that the visual light transmittance (VLT) of the laminate adhesive layer 230 may be any value between any of the minimum and maximum values noted above.

According to particular embodiments, the laminate adhesive layer 230 may have a particular haze. For purposes of embodiments described herein, the haze of a particular component is defined as defined as the percentage of transmitted light that is scattered by the component at an angle greater than 2.5 degree from the incident beam and is measured according to ASTM D1003. According to particular embodiments, the laminate adhesive layer 230 may have a haze of at least about 0.5%, such as at least about 1.0% or at least about 1.5% or at least about 2.0% or even at least about 2.5%. According to still other embodiments, the laminate adhesive layer 230 may have a haze of not greater than about 4.0%, such as not greater than about 3.5% or even not greater than about 3.0%. It will be appreciated that the haze of the laminate adhesive layer 230 may be within a range between any of the minimum and maximum values noted above. It will be further appreciated that the haze of the laminate adhesive layer 230 may be any value between any of the minimum and maximum values noted above.

According to still other embodiments, the laminate adhesive layer 230 may include the nano-ceramic particles. According to still other embodiments, the nano-ceramic particle may include antimony doped antimony tin oxide (ATO), cesium tungsten oxide (CWOx), and indium tin oxide (ITO), or any combination thereof. According to still other embodiments, the nano-ceramic particles may consist essentially of antimony doped antimony tin oxide (ATO), cesium tungsten oxide (CWOx), and indium tin oxide (ITO), or any combination thereof.

According to still other embodiments, the laminate adhesive layer 230 may include a polyester based adhesive, a polyurethane based adhesive, an acrylic based adhesive, or any combination thereof.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A multilayer film comprising a protection component, and a solar control component, wherein the protection component comprises a protection component structural substrate, and a protective hard coating overlying the protection component structural substrate; wherein the solar control component comprises a pressure sensitive adhesive; wherein the multilayer film comprises nano-ceramic particles; wherein the multilayer film comprises delta haze value of not greater than about 4%; wherein the multilayer film comprises a UV degradation resistance of at least about 400 MJ/m²; and wherein the multilayer film comprises a total solar energy rejection (TSER) of at least about 30%.

Embodiment 2. A multilayer film comprising a protection component, a solar control component, and a laminating adhesive layer between the protection component, and the solar control component, wherein the protection component comprises a protection component structural substrate, and a protective hard coating overlying the first structural substrate; wherein the solar control component comprises solar control component structural substrate, a solar control coating overlying the solar control component structural substrate, and a pressure sensitive adhesive underlying the solar control structural substrate; wherein the multilayer film comprises nano-ceramic particles; wherein the multilayer film comprises delta haze value of not greater than about 4%; wherein the multilayer film comprises a UV degradation resistance of at least about 400 MJ/m²; and wherein the multilayer film comprises a total solar energy rejection (TSER) of at least about 30%.

Embodiment 3. The multilayer film of embodiment 1, wherein the multilayer film has a VLT of at least about 70%.

Embodiment 4. The multilayer film of embodiment 1, wherein the multilayer film has a VLT of not greater than about 94%.

Embodiment 5. The multilayer film of embodiment 1, wherein the multilayer film has a haze of at least about 0.5%.

Embodiment 6. The multilayer film of embodiment 1, wherein the multilayer film has a haze of not greater than about 4%.

Embodiment 7. The multilayer film of embodiment 1, wherein the nano-ceramic particles comprise antimony doped antimony tin oxide (ATO), cesium tungsten oxide (CWOx), and indium tin oxide (ITO), or any combination thereof.

Embodiment 8. The multilayer film of embodiment 1, wherein the protection component has a thickness of at least about 10 microns.

Embodiment 9. The multilayer film of embodiment 1, wherein the protection component has a thickness of not greater than about 250 microns.

Embodiment 10. The multilayer film of embodiment 1, wherein the protection component has a VLT of at least about 70%.

Embodiment 11. The multilayer film of embodiment 1, wherein the protection component has a VLT of not greater than about 94%.

Embodiment 12. The multilayer film of embodiment 1, wherein the protection component has a haze of at least about 0.5%.

Embodiment 13. The multilayer film of embodiment 1, wherein the protection component has a haze of not greater than about 4%.

Embodiment 14. The multilayer film of embodiment 1, wherein protection component comprises nano-ceramic particles and wherein the nano-ceramic particles comprise antimony tin oxide (ATO), cesium tungsten oxide (CWOx), and indium tin oxide (ITO), or any combination thereof.

Embodiment 15. The multilayer film of embodiment 1, wherein the solar control component has a thickness of at least about 10 microns.

Embodiment 16. The multilayer film of embodiment 1, wherein the solar control component has a thickness of not greater than about 250 microns.

Embodiment 17. The multilayer film of embodiment 1, wherein the solar control component has a VLT of at least about 70%.

Embodiment 18. The multilayer film of embodiment 1, wherein the solar control component has a VLT of not greater than about 90%.

Embodiment 19. The multilayer film of embodiment 1, wherein the solar control component has a haze of at least about 0.5%.

Embodiment 20. The multilayer film of embodiment 1, wherein the solar control component has a haze of not greater than about 4%.

Embodiment 21. The multilayer film of embodiment 1, wherein protection component comprises nano-ceramic particles and wherein the nano-ceramic particles comprise antimony tin oxide (ATO), cesium tungsten oxide (CWOx), and indium tin oxide (ITO), or any combination thereof.

Embodiment 22. The multilayer film of embodiment 1, wherein the protection component structural substrate comprises thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof.

Embodiment 23. The multilayer film of embodiment 1, wherein the protection component structural substrate has a thickness of at least about 10 microns.

Embodiment 24. The multilayer film of embodiment 1, wherein the protection component structural substrate has a thickness of not greater than about 250 microns.

Embodiment 25. The multilayer film of embodiment 1, wherein the protective hard coating comprises a UV curable hardcoat, a silicone hardcoat, a polyester hardcoat, a polyurethane hardcoat, a hardcoat comprising silica particles, a hardcoat comprising UV absorbers, or any combination thereof.

Embodiment 26. The multilayer film of embodiment 1, wherein the protective hard coating has a thickness of at least about 0.5 microns.

Embodiment 27. The multilayer film of embodiment 1, wherein the protective hard coating has a thickness of not greater than about 25 microns.

Embodiment 28. The multilayer film of embodiment 1, wherein the protective hard coating comprises nano-ceramic particles and wherein the nano-ceramic particles comprise antimony tin oxide (ATO), cesium tungsten oxide (CWOx), and indium tin oxide (ITO), or any combination thereof.

Embodiment 29. The multilayer film of embodiment 1, wherein the protective hard coating comprises acrylic binders, silicone binders, polyester binders, polyurethane binders, or any combination thereof.

Embodiment 30. The multilayer film of embodiment 1, wherein the pressure sensitive adhesive comprises an acrylic based pressure sensitive adhesive, a natural rubber-based pressure sensitive adhesive, a synthetic rubber-based pressure sensitive adhesive, a silicone-based pressure sensitive adhesive, or any combination thereof.

Embodiment 31. The multilayer film of embodiment 1, wherein the pressure sensitive adhesive has a thickness of at least about 0.5 microns.

Embodiment 32. The multilayer film of embodiment 1, wherein the pressure sensitive adhesive has a thickness of not greater than about 25 microns.

Embodiment 33. The multilayer film of embodiment 1, wherein the pressure sensitive adhesive comprises nano-ceramic particles and wherein the nano-ceramic particles comprise antimony tin oxide (ATO), cesium tungsten oxide (CWOx), and indium tin oxide (ITO), or any combination thereof.

Embodiment 34. The multilayer film of embodiment 2, wherein the multilayer film has a VLT of at least about 70%.

Embodiment 35. The multilayer film of embodiment 2, wherein the multilayer film has a VLT of not greater than about 94%.

Embodiment 36. The multilayer film of embodiment 2, wherein the multilayer film has a haze of at least about 0.5%.

Embodiment 37. The multilayer film of embodiment 2, wherein the multilayer film has a haze of not greater than about 4%.

Embodiment 38. The multilayer film of embodiment 2, wherein the nano-ceramic particles comprise antimony doped antimony tin oxide (ATO), cesium tungsten oxide (CWOx), and indium tin oxide (ITO), or any combination thereof.

Embodiment 39. The multilayer film of embodiment 2, wherein the protection component has a thickness of at least about 10 microns.

Embodiment 40. The multilayer film of embodiment 2, wherein the protection component has a thickness of not greater than about 250 microns.

Embodiment 41. The multilayer film of embodiment 2, wherein the protection component has a VLT of at least about 70%.

Embodiment 42. The multilayer film of embodiment 2, wherein the protection component has a VLT of not greater than about 94%.

Embodiment 43. The multilayer film of embodiment 2, wherein the protection component has a haze of at least about 0.5%.

Embodiment 44. The multilayer film of embodiment 2, wherein the protection component has a haze of not greater than about 4%.

Embodiment 45. The multilayer film of embodiment 2, wherein the protection component comprises nano-ceramic particles and wherein the nano-ceramic particles comprise antimony tin oxide (ATO), cesium tungsten oxide (CWOx), and indium tin oxide (ITO), or any combination thereof.

Embodiment 46. The multilayer film of embodiment 2, wherein the solar control component has a thickness of at least about 10 microns.

Embodiment 47. The multilayer film of embodiment 2, wherein the solar control component has a thickness of not greater than about 250 microns.

Embodiment 48. The multilayer film of embodiment 2, wherein the solar control component has a VLT of at least about 70%.

Embodiment 49. The multilayer film of embodiment 2, wherein the solar control component has a VLT of not greater than about 90%.

Embodiment 50. The multilayer film of embodiment 2, wherein the solar control component has a haze of at least about 0.5%.

Embodiment 51. The multilayer film of embodiment 2, wherein the solar control component has a haze of not greater than about 4%.

Embodiment 52. The multilayer film of embodiment 2, wherein protection component comprises nano-ceramic particles and wherein the nano-ceramic particles comprise antimony tin oxide (ATO), cesium tungsten oxide (CWOx), and indium tin oxide (ITO), or any combination thereof.

Embodiment 53. The multilayer film of embodiment 2, wherein the laminate adhesive layer has a thickness of at least about 1 micron.

Embodiment 54. The multilayer film of embodiment 2, wherein the laminate adhesive layer has a thickness of not greater than about 25 microns.

Embodiment 55. The multilayer film of embodiment 2, wherein the laminate adhesive layer has a VLT of at least about 70%.

Embodiment 56. The multilayer film of embodiment 2, wherein the laminate adhesive layer has a VLT of not greater than about 98%.

Embodiment 57. The multilayer film of embodiment 2, wherein the laminate adhesive layer has a haze of at least about 0.2%.

Embodiment 58. The multilayer film of embodiment 2, wherein the laminate adhesive layer has a haze of not greater than about 3%.

Embodiment 59. The multilayer film of embodiment 2, wherein the laminate adhesive layer comprises nano-ceramic particles and wherein the nano-ceramic particles comprise antimony tin oxide (ATO), cesium tungsten oxide (CWOx), and indium tin oxide (ITO), or any combination thereof.

Embodiment 60. The multilayer film of embodiment 2, wherein the laminate adhesive layer comprises a polyester-based adhesive, a polyurethane-based adhesive, an acrylic based adhesive, or any combination thereof.

Embodiment 61. The multilayer film of embodiment 2, wherein the protection component structural substrate comprises thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof.

Embodiment 62. The multilayer film of embodiment 2, wherein the protection component structural substrate has a thickness of at least about 10 microns.

Embodiment 63. The multilayer film of embodiment 2, wherein the protection component structural substrate has a thickness of not greater than about 250 microns.

Embodiment 64. The multilayer film of embodiment 2, wherein the protective hard coating comprises a UV curable hardcoat, a silicone hardcoat, a polyester hardcoat, a polyurethane hardcoat, a hardcoat comprising silica particles, a hardcoat comprising UV absorbers, or any combination thereof.

Embodiment 65. The multilayer film of embodiment 2, wherein the protective hard coating has a thickness of at least about 0.5 microns.

Embodiment 66. The multilayer film of embodiment 2, wherein the protective hard coating has a thickness of not greater than about 25 microns.

Embodiment 67. The multilayer film of embodiment 2, wherein the protective hard coating comprises nano-ceramic particles and wherein the nano-ceramic particles comprise antimony tin oxide (ATO), cesium tungsten oxide (CWOx), and indium tin oxide (ITO), or any combination thereof.

Embodiment 68. The multilayer film of embodiment 2, wherein the protective hard coating comprises acrylic binders, silicone binders, polyester binders, polyurethane binders, or any combination thereof.

Embodiment 69. The multilayer film of embodiment 2, wherein the solar control component structural substrate comprises thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof.

Embodiment 70. The multilayer film of embodiment 2, wherein the solar control component structural substrate has a thickness of at least about 10 microns.

Embodiment 71. The multilayer film of embodiment 2, wherein the solar control component structural substrate has a thickness of not greater than about 250 microns.

Embodiment 72. The multilayer film of embodiment 2, wherein the solar control coating comprises nano-ceramic particles and binders such as UV curable, polyester binders, or urethane binder.

Embodiment 73. The multilayer film of embodiment 2, wherein the solar control coating has a thickness of at least about 1 micron.

Embodiment 74. The multilayer film of embodiment 2, wherein the solar control coating has a thickness of not greater than about 25 microns.

Embodiment 75. The multilayer film of embodiment 2, wherein the solar control coating comprises nano-ceramic particles and wherein the nano-ceramic particles comprise antimony tin oxide (ATO), cesium tungsten oxide (CWOx), and indium tin oxide (ITO), or any combination thereof.

Embodiment 76. The multilayer film of embodiment 2, wherein the solar control coating comprises nano-ceramic particles, binders such as UV curable acrylic, polyester, polyurethane, and acrylic binder(s).

Embodiment 77. The multilayer film of embodiment 2, wherein the pressure sensitive adhesive comprises an acrylic based pressure sensitive adhesive, a natural rubber-based pressure sensitive adhesive, a synthetic rubber-based pressure sensitive adhesive, a silicone-based pressure sensitive adhesive, or any combination thereof.

Embodiment 78. The multilayer film of embodiment 2, wherein the pressure sensitive adhesive has a thickness of at least about 0.5 microns.

Embodiment 79. The multilayer film of embodiment 2, wherein the pressure sensitive adhesive has a thickness of not greater than about 25 microns.

Embodiment 80. The multilayer film of embodiment 2, wherein the pressure sensitive adhesive comprises nano-ceramic particles and wherein the nano-ceramic particles comprise antimony tin oxide (ATO), cesium tungsten oxide (CWOx), and indium tin oxide (ITO), or any combination thereof.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A multilayer film comprising a protection component, and a solar control component,
wherein the protection component comprises a protection component structural substrate, and a protective hard coating overlying the protection component structural substrate;
wherein the solar control component comprises a pressure sensitive adhesive;
wherein the multilayer film comprises nano-ceramic particles;
wherein the multilayer film comprises delta haze value of not greater than about 4%;
wherein the multilayer film comprises a UV degradation resistance of at least about 400 MJ/m²; and
wherein the multilayer film comprises a total solar energy rejection (TSER) of at least about 30%.

2. A multilayer film comprising a protection component, a solar control component, and a laminating adhesive layer between the protection component, and the solar control component,
wherein the protection component comprises a protection component structural substrate, and a protective hard coating overlying the first structural substrate;
wherein the solar control component comprises solar control component structural substrate, a solar control coating overlying the solar control component structural substrate, and a pressure sensitive adhesive underlying the solar control structural substrate;
wherein the multilayer film comprises nano-ceramic particles;
wherein the multilayer film comprises delta haze value of not greater than about 4%;
wherein the multilayer film comprises a UV degradation resistance of at least about 400 MJ/m²; and
wherein the multilayer film comprises a total solar energy rejection (TSER) of at least about 30%.

3. The multilayer film of claim 1, wherein the multilayer film has a VLT of at least about 70% and not greater than about 94%.

4. The multilayer film of claim 1, wherein the multilayer film has a haze of at least about 0.5% and not greater than about 4%.

5. The multilayer film of claim 1, wherein the nano-ceramic particles comprise antimony doped antimony tin oxide (ATO), cesium tungsten oxide (CWOx), and indium tin oxide (ITO), or any combination thereof.

6. The multilayer film of claim 1, wherein the protection component has a thickness of at least about 10 microns and not greater than about 250 microns.

7. The multilayer film of claim 1, wherein the protection component has a VLT of at least about 70% and not greater than about 94%.

8. The multilayer film of claim 1, wherein the protection component has a haze of at least about 0.5% and not greater than about 4%.

9. The multilayer film of claim 1, wherein protection component comprises nano-ceramic particles and wherein the nano-ceramic particles comprises antimony tin oxide (ATO), cesium tungsten oxide (CWOx), and indium tin oxide (ITO), or any combination thereof.

10. The multilayer film of claim 1, wherein the solar control component has a thickness of at least about 10 and not greater than about 250 microns.

11. The multilayer film of claim 1, wherein the solar control component has a VLT of at least about 70% and not greater than about 90%.

12. The multilayer film of claim 1, wherein the solar control component has a haze of at least about 0.5% and not greater than about 4%.

13. The multilayer film of claim 1, wherein protection component comprises nano-ceramic particles and wherein the nano-ceramic particles comprises antimony tin oxide (ATO), cesium tungsten oxide (CWOx), and indium tin oxide (ITO), or any combination thereof.

14. The multilayer film of claim 1, wherein the protection component structural substrate comprises thermoplastic polyurethane, enhanced polyurethane, polyethylene terephthalate (PET), polystyrene, polyvinyl chloride (PVC), polymethyl methacrylate (PMMA), polycarbonate (PC), acrylates, and combinations thereof.

15. The multilayer film of claim 1, wherein the protection component structural substrate has a thickness of at least about 10 microns and not greater than about 250 microns.

16. The multilayer film of claim 2, wherein the multilayer film has a VLT of at least about 70% and not greater than about 94%.

17. The multilayer film of claim 2, wherein the multilayer film has a haze of at least about 0.5% and not greater than about 4%.

18. The multilayer film of claim 2, wherein the nano-ceramic particles comprise antimony doped antimony tin oxide (ATO), cesium tungsten oxide (CWOx), and indium tin oxide (ITO), or any combination thereof.

19. The multilayer film of claim 2, wherein the protection component has a thickness of at least about 10 microns and not greater than about 250 microns.

20. The multilayer film of claim 2, wherein the protection component has a VLT of at least about 70% and not greater than about 94%.
